(19) United States
(12) Patent Application Publication
(10) Pub. No.: US 2010/0052605 A1
(43) Pub. Date: Mar. 4, 2010

(54) Supplement wind turbine car charging system

(76) Inventors: James David Prestridge, Clanton, AL (US); Aaron Alphuus Harlan, Muscadine, AL (US)

Correspondence Address: James David Prestridge, 168 County Road 454, Clanton, AL, 35046, US

(21) Appl. No.: 12/214,199

(22) Filed: Sep. 2, 2008

(51) Int. Cl. H02J 7/00

(52) U.S. Cl. 320/101

(57) ABSTRACT

This disclosure will describe a system for supplementing or replacing the gasoline engine in a modern hybrid automobile. By taking advantage of the airflow surrounding a vehicle at moderate highway speeds thorough the use of modern electric turbines and generators, this system will allow the gasoline engine to be replaced completely or greatly extend the available range of a given vehicle by recharging the onboard batteries by wind power. It is possible with this system to dramatically reduce fuel consumption and extend the life of the vehicle by more careful charging of the batteries and reduced wear and tear on the gasoline engines if so equipped.

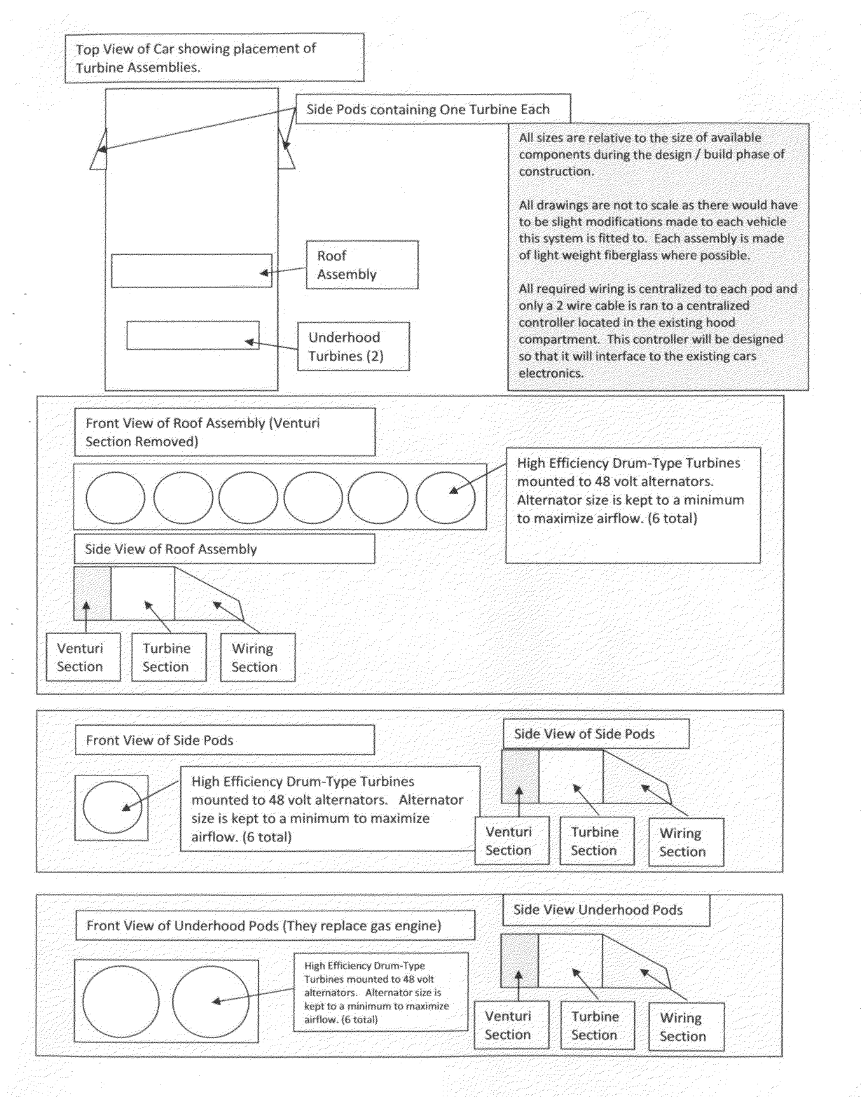

Replacing the gas engine in a hybrid vehicle has obvious advantages, the least of which is the ability to never have to purchase gasoline at our outrageous prices again. This system should be able to work with any existing hybrid vehicle and increase the range of said vehicle while removing the added weight and complexity of a gasoline engine. The basic design will remain the same regardless of the vehicle it will be mounted to, but it will be modified to fit the aesthetics of whichever vehicle it is mounted to. This article will define the various major parts of the system and the basics on how to install and use the system. The parts are turbines, wiring, electronic interface and venturis.

The turbines are the key to this system. We are investigating the use of drum type turbines for the two main reasons of size and efficiency. You can easily mount these in a streamlined cowling on the outside of the vehicle body so that they will be in the available airstream that flows around all vehicles. The key design point is getting the turbines at operating efficiency at speeds above 30 mph. The turbines will be mounted to the roof of the vehicle in a low profile housing that will funnel out through the turbine assembly and continue flowing around the vehicle aerodynamics. The roof assembly will contain 4 to 6 turbines depending on the width of the vehicle. They will also be mounted in scoop style pod on either side of the vehicle near the rear. These will contain one turbine each. There will also be two or three larger turbines mounted under the vehicle hood two provide even more power.

The wiring and electronic interface will be defined to minimize the wiring necessary and will further reduce the weight and complexity of the system. Each turbine assembly will have all the necessary wiring contained in the pod so that only one high voltage cable will have to be routed to the main electronic interface. The wiring pods will contain all the necessary controls to vary the load on the turbines, regulate the voltage and maintain the proper voltage to the electronics interface. The turbines will be mounted to a high efficiency alternator to provide the actual voltage to the system.

The venturis will be mounted in front of the turbine and will be designed to increase airflow through the turbines and minimize the aerodynamic load on the vehicle. The venturi will enable the turbines to operate at low speeds and with great efficiency.

The electronic interface will perform two key functions. First it will regulate and control the voltage coming from the turbines and enable controls and performance indicators that will indicate the efficiency of the system and what parts are actually in what state. Secondly it will provide the interface to the cars existing electronics system to provide control and power to the existing onboard batteries, electronics and motors.

The following claims are made concerning this system:

1. This system will greatly reduce the need for gasoline power through the electricity generated by the turbines.

2. The drivable range of modified vehicles will be greatly increased due to the application of additional power provided through the turbine system.

3. Useable life of the on-board batteries will be increased due to the more continuous and gently use of the batteries. The system should generate enough power at speed to not need the use of batteries on a regular basis.
